(19) United States
(12) Patent Application Publication
(10) Pub. No.: US 2010/0151400 A1
(43) Pub. Date: Jun. 17, 2010

(54) PROCESS FOR THE SMOOTH CONTROLLED HEATING OF CHEMICAL SUBSTANCES WITH DIFINED ENTRY AND EXIT TEMPERATURES IN A HEATER AND APPARATUS FOR CARRYING OUT THE PROCESS

(75) Inventors: Harald Troll, Alzenau (DE); Peter Adler, Rheinfelden (DE); Michael Beyer, Berlin (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GMBH, Essen (DE)

(21) Appl. No.: 12/593,765

(22) PCT Filed: Mar. 14, 2008
(86) PCT No.: PCT/EP08/53079

§ 371 Date: Sep. 29, 2009

(30) Foreign Application Priority Data
Mar. 29, 2007 (DE) 102007015619.9
Oct. 31, 2007 (DE) 102007052325.6

(51) Int. Cl. F27D 19/00; F27D 15/02; F27D 3/00

(52) U.S. Cl. 432/29; 432/77; 432/239

(57) ABSTRACT

The invention relates to a method for the gradual temperature control of chemical substances with defined entry and exit temperatures in a heater, said substances being maintained in a specific defined temperature range as they are conducted through the heater, and to a device for carrying out said method. The aim of the invention is to provide a suitable method and device for carrying out said method, said device permitting an economically advantageous, reliable and environmentally friendly operation, in particular during the start-up process for the device. This aim is achieved by the features according to the invention mentioned in claims 1;11 and 19; 22.

The invention relates to a process for the smooth controlled heating of chemical substances with defined entry and exit temperatures in a heater, which are passed through the heater while being maintained in a particular defined pressure range and also an apparatus for carrying out the process.

Heating chemical substances of various compositions by means of electrically operated heaters in industrial processes is known. This type of controlled heating of chemical substances, which in this case can also be water, can only be carried out when the amount of the chemical substance is not large. Heating by such a method is very costly and completely unsuitable from an economic point of view. In the case of large amounts of the substances, it is necessary to carry out heating of these in a fired heater, as is generally customary in the vaporization or superheating of water. A disadvantage of the latter processes is that the start-up process has to be carried out over relatively long periods of time with a high energy consumption. During the start-up process, considerable amounts of energy are supplied to the heater or the overall plant without economic effect to reach the end stage and are given off unutilized to the surroundings.

It is an object of the invention to provide a process for the smooth controlled heating of chemical substances which are maintained at particular entry and exit temperatures and a particular pressure level by means of a heater, and also an apparatus for carrying out the process which allows economically advantageous, safe and environmentally friendly operation, in particular during the start-up process of the apparatus.

According to the invention, the object is achieved by means of a process for the smooth controlled heating of chemical substances at defined input and output temperatures in a heater, which are passed through the heater while being maintained in a particular defined pressure range and the smooth controlled heating is initiated in a start-up process in a start-up facility inserted between the inlet and outlet of the heater, in which the smooth controlled heating of the chemical substances is carried out with inlet and outlet closed by means of multiple flow through the heater and the facility until the defined temperature and the predetermined pressure have been reached and, when the defined pressure and temperature conditions have been established, the start-up process is terminated and direct flow through the heater from the inlet to the outlet is established by closing off the start-up facility. In an embodiment of the invention, the start-up facility is arranged in the apparatus as a bridge between an inlet upstream of the heater and the outlet downstream of the heater and is equipped with functional devices such as an equilibration vessel, a water cooler or air cooler and a circulation pump. In an advantageous embodiment of the invention, the apparatus for the smooth controlled heating of chemical substances at defined entry and exit temperatures has a heater in which the medium in the apparatus is brought to a supercritical temperature range before exit from the heater at a defined temperature level for the subsequent working steps and the medium is brought by the heater by means of the start-up facility into a circular, closed start-up process at rising temperature and fill level which is set and maintained while maintaining a predetermined pressure until leaving the heater. An advantageous overview of the embodiment of the invention is given by the features of the smooth controlled heating, which is carried out using the following process steps:
filling of the heater
establishment of a gas cushion in an equilibration vessel of the start-up facility so as to achieve the required process pressure
closing of the valves in the inlet and outlet of the apparatus
circulation for treatment of the chemical substances with switching on of the start-up facility of the apparatus in a steady-state circulation process, starting of the introduction of heat by means of the heater
introduction of the chemical substances into the downstream processing regions with switching off of the start-up process and the associated start-up facility according to the invention
maintenance of continuous operation of the apparatus by conveying the chemical substances from the chemicals tank of the apparatus by the heater into the subsequent working region.

In a further advantageous embodiment of the invention, both the heater and the start-up facility are filled with gas which passes through the chemical substances present into an expansion vessel of the start-up facility and this is placed under pressure until the heater and the apparatus are completely filled. In a further embodiment, readiness for operation is established by multiple circulation of the chemical substances in the apparatus and by the heater with maintenance of a required fill level for the apparatus and the feed pump located downstream of the chemicals tank of the apparatus is switched off, with the chemical substance in the apparatus being brought to, set and maintained in the region of a critical pressure by production of a pressure cushion by means of an inert gas in an advantageous development of the invention. In a further advantageous embodiment of the process of the invention, the burner of the heater is started while maintaining circulation of the chemical substance via the switched-on start-up facility assigned to the apparatus, the temperature of the chemical substance is changed and adjusted by means of continual heat exchange between a cooler and the chemical substance until a temperature equilibrium of the cooler and the total heater power is established and the increased volume of the chemical substance is accommodated by means of the equilibration vessel, the pressure to be defined is established by adjustment of the gas cushion and the operating state of the apparatus is maintained. In a further advantageous embodiment of the invention, the heated chemical substance is, when the required temperature and the pressure have been reached in the heater, displaced by targeted introduction of chemical substance which has been subjected to a lesser temperature change and at the transition is discharged from the heater, with the exit temperature being subjected to fine regulation by means of injection cooling into the chemical substance and its excess temperature being returned to the normal regime and the continuous stream of the chemical substance being adjusted for uniform passage with switching off of the start-up facility. In a further embodiment of the invention, the output quantity of the chemical substance is, in full load operation, offset in a defined ratio from the required operating pressure and the temperature and pressure of the apparatus are kept constant by regulation of the heat input and conducted to full load, with temperature deviations being compensated by introduction of chemical substances which have been subjected to a lesser temperature change. In one embodiment of the invention, the entry temperature of the chemical substance into the overall apparatus is from 10 to 30° C., preferably 20° C., and, in a further embodiment of the invention, the exit temperature of a chemical substance is up to 610° C., preferably from 550 to 600° C. In a further embodiment of the invention, the pressure of the apparatus is also considered to be set with supercritical parameters. In a further advantageous embodiment of the invention, the operating pressure of the apparatus is set to a supercritical pressure of, for example, from 35 to 40 bar. In an advantageous embodiment of the invention, a gas cushion is established in the expansion vessel of the start-up facility by introduction of inert gas in order to set the defined pressure in the start-up facility of the apparatus. In an advantageous embodiment of the invention, the start-up process of the overall apparatus is carried out via a bridging line configured as start-up facility between the feed and discharge lines of the assigned start-up facility with cyclically repeated circulation through the heater which is ended when the defined temperature and the operating pressure of the apparatus have been reached. In a useful embodiment of the invention, the start-up facility is arranged in the apparatus as a bridge between the inlet upstream of the heater and the outlet downstream of the heater and is equipped with functional devices such as an equilibration vessel, a cooler and a circulation pump. A person skilled in the art will recognize that another embodiment of the invention is obtained when the cooler is operated by means of various media such as, as desired, water or air.

In a further embodiment of the invention, the smooth controlled heating is initiated in the start-up process in a start-up facility inserted between the inlet and outlet of the heater, in which the smooth controlled heating of the chemical substance is carried out with inlet and outlet closed by means of multiple flow through the heater and the facility and the chemical substance coming from the heater in the flow direction of the start-up process is fed to a cooler, cooled therein and thus changed in temperature, is passed through a shut-off valve, flows into an expansion vessel into which the substance is introduced for volume and pressure equilibration, a volume equilibrium of the chemical substance between the expansion vessel and the main line downstream of the heater in the start-up facility is established with the aid of a connection to the main line and the chemical substance at the same time flows into the main feed line upstream of the heater in the start-up process. In a useful embodiment of the invention, the chemical substance flows in the cooled state to the shut-off valve and is moved by a circulation pump, kept flowing in the opposite direction between the main line assigned to the heater and the expansion vessel, wherein the chemical substance whose temperature has been changed coming from the heater is fed directly to a cooler and is conveyed in a cool state to the expansion vessel to establish volume and pressure equilibration and fed back to the circuit of the start-up process. In an advantageous embodiment of the invention, the stream whose temperature is to be changed is formed by chemical substances having vaporizable properties.

In a further embodiment of the invention, the stream whose temperature is to be changed is formed by chemical substances having vaporizable properties and substance mixtures consisting thereof.

In an advantageous embodiment of the invention, the process of the invention is applied to vaporizable chemical substances or appropriate mixtures thereof, including protective mixtures, which are, in particular, starting materials for chemical processes. Examples which may be mentioned are: hydrogen, oxygen, ozone, nitrogen, halogens, noble gases, carbon monoxide, carbon dioxide, nitrogen oxides, hydrogen halides such as HCl, water, ammonia, synthesis gas, natural gas, hydrocarbons such as C1-C16-alkanes, for example methane, propane, butane, isooctanes, in particular hydrocarbon fractions from petroleum refining, halogenated hydrocarbons such as methyl chloride, methyl dichloride, vinyl chloride, carbon tetrachloride, olefins such as ethylene, propylene, butenes, alkynes such as acetylene, aromatics, alcohols such as methanol, ethanol, n- and i-propanol, n-, i- and t-butanol, polyalcohols, aldehydes, ketones, carboxylic acids, acid amides, amino acids, amines, ethers such as dimethyl ether, diethyl ether, methyl t-butyl ether, ethyl t-butyl ether, esters, sulfur compounds such as hydrogen sulfide, organosulfur compounds, organophosphorus compounds, organometallic compounds, germanes, silanes, in particular organosilanes or chlorosilanes and also siloxanes, for example, but not exclusively, hexamethyldisiloxane, tetramethylsilane, trimethylchlorosilane, dimethyldichlorosilane, methyltrichlorosilane, chloromethyldimethylchlorosilane, chloromethyltrichlorosilane, 2-chloroethyltrichlorosilane, 3-chloropropyltrichlorosilane, 3-chloro-2-methylpropyltrichlorosilane, polychlorosilanes, polysilanes, monosilane, monochlorosilane, dichlorosilane, trichlorosilane, tetrachlorosilane, to name only a few examples, or mixtures of two or more of the abovementioned substances.

The invention further provides an apparatus for the controlled heating of a chemical substance having defined entry and exit temperatures by means of a heater which is connected to a chemicals tank by a first line for introduction and via a second main line for discharge of the substance into a subsequent process and from the second line to the first main line there is a start-up facility for starting up the apparatus, by means of which a smooth controlled heating is effected by means of circulating chemical substance through the heater with the valve of the second main line closed and inflow of a chemical substance via the open valve of the start-up facility downstream of which there is a cooler which is followed by a shut-off valve which feeds the chemical substance to a pump which conveys it to a valve via which, with the valve open, the chemical substance goes into the part of the first line, flows back into the heater in which it is subjected to an increasing temperature, repeatedly flows in a circulating fashion into the main line and, when the defined exit temperature has been established and the defined pressure has been established, is conveyed, with valves of the lines of the main process open and valves of the start-up facility closed and with the start-up facility switched off, via the second main line to a transition.

In a further embodiment of the invention, the start-up facility for smooth controlled heating in the start-up process is switched on and has an inlet valve in the region of the second main line which is connected to an expansion vessel which, in active communication with a cooler, conveys the chemical substance to a circulation pump which conveys the chemical substance via a valve into the part of the line of the first main line connected to the heater and circulation in the facility is continued until the defined operating parameters of the apparatus have been reached.

In a particular embodiment of the invention, the chemical substance flows into the start-up facility through the open valve into the expansion vessel which is filled with inert gas and in which the defined pressure of the chemical substance is set continuously and incrementally by means of a gas cushion and then goes to an air cooler which is kept in operation until, as a gradated small heat input into the apparatus, a steady and equilibrium state has been reached, with the circulation pump feeding the chemical substance via the open valve into the inlet leading to the heater. In an embodiment which is preferred for the purposes of the invention, smooth controlled heating is effected in the start-up facility for starting up the apparatus by circulation of the stream of substance through the heater. The start-up process is carried out with the valve of the feed and discharge lines closed. The chemical substance flows from the heater via a feed line directly into a cooler which is arranged directly downstream of the heater. The stream of substance goes via a shut-off valve to a pump which feeds it to a further line section of the first main line and allows it to flow via an ascending line section into an expansion vessel which effects pressure and volume equilibration of the start-up facility. Between the expansion vessel and the main line section through which the stream is discharged there is a further line which establishes pressure equilibration between the expansion vessel and the part of the main line through which the stream is discharged. The line located between the expansion vessel and the main line section provides a closable connection to the main line. A further line with a valve is provided in order to be able to introduce inlet gas into the expansion vessel. In a further embodiment of the invention, the chemical substance coming from the heater in the circuit of the start-up process goes into the cooler and through a downstream valve and goes via a further line through a circulation pump to the feed part of the main line.

The process of the invention has the advantage that the chemical substance makes the outlay in terms of apparatus for the start-up facility smaller and increases its functional reliability because it is now fed in a cooled state via the circulation pump to the equilibration vessel and ensures its functional reliability. In a further embodiment of the invention, the heater is formed by a hermetically sealed, pressure-resistant body into whose fire chamber the flame of a burner projects, with the walls of the fire chamber being provided with axially and radially aligned heater tubes which are arranged in a plurality of stages and are connected to one another and through which the chemical substance flows and which are heated by means of a flue gas stream which changes its direction a plurality of times, with the highest temperature level in each case being reached in the heater tubes located radially outside.

In a further advantageous embodiment of the invention, a defined temperature in the heater is set by heating using waste heat from an upstream process.

In apparatuses for the controlled heating of chemical substances having different sizes, the invention ensures extremely economical start-up of the apparatus by the provision of the start-up facility in the overall apparatus. The start-up facility ensures that the start-up process for the controlled heating of the apparatus after filling of all components of the apparatus including the start-up facility occurs smoothly by means of circulation of the chemical substance through the start-up facility and the heater until the temperature defined for the regime has been reached. The circulation of the chemical substance is carried out while the feed and discharge lines of the main lines are closed off. The disadvantageous stepwise raising of the temperature in apparatuses of this type until the temperature necessary for the process has been reached which has hitherto been necessary is dispensed with. The circulation of the chemical substance through the heater and the start-up facility enables not only smooth controlled heating to be carried out but at the same time allows any desired pressure level up to a supercritical pressure to be set in the start-up process.

The invention is illustrated by an example.

The associated drawing shows:

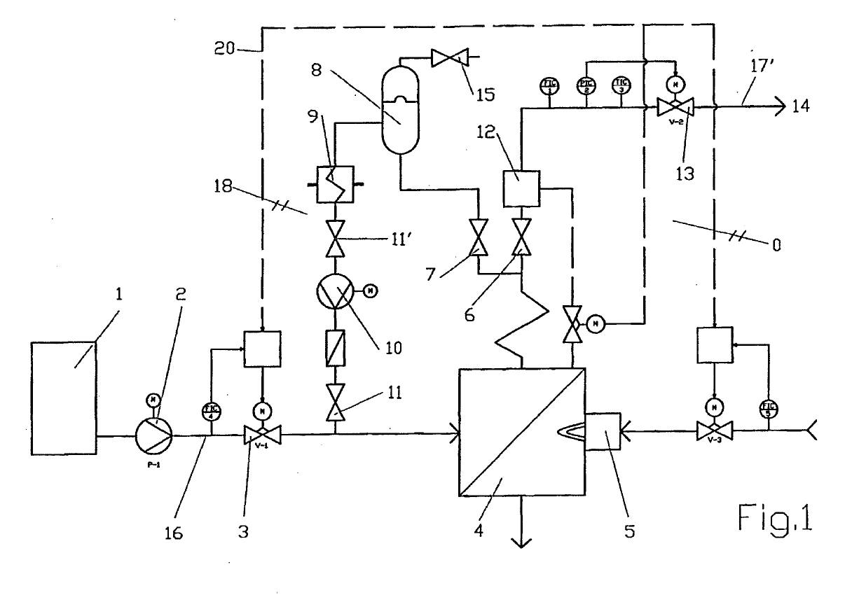

FIG. 1: A schematic depiction of the apparatus with included start-up facility

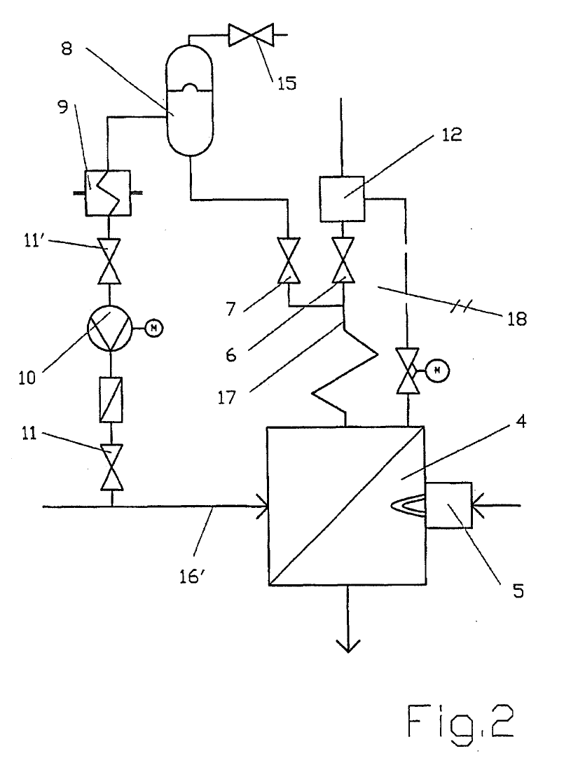

FIG. 2: A detail of the facility of FIG. 1

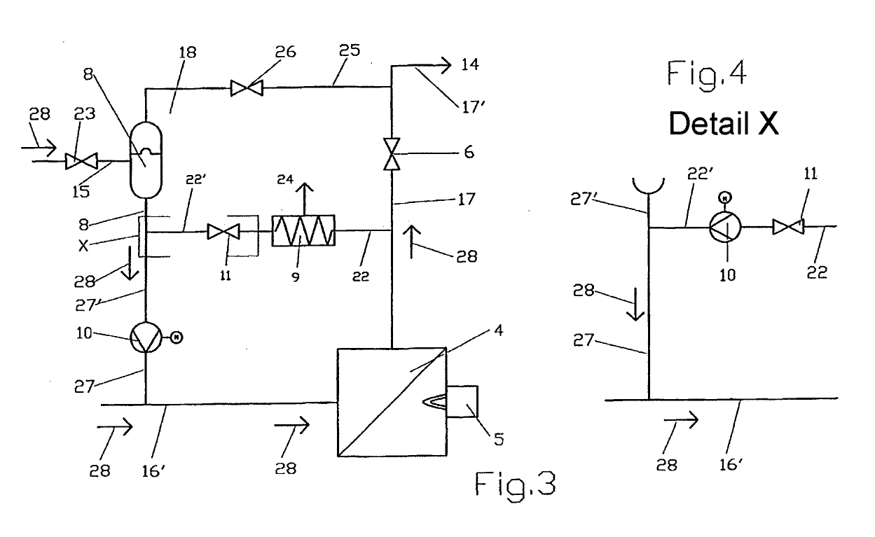

FIG. 3: A further embodiment of the start-up facility

FIG. 4: A varied embodiment of the start-up facility of FIG. 3

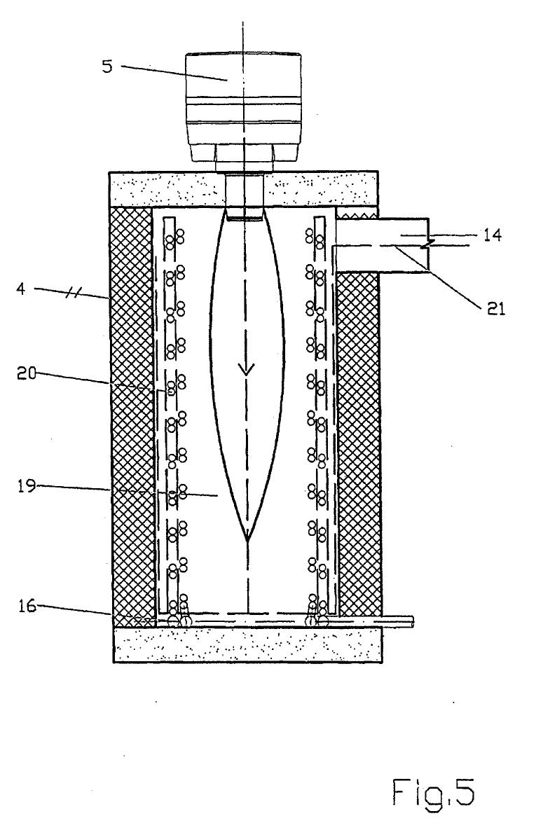

FIG. 5: A schematic depiction of the heater of FIG. 1 shown enlarged in side elevation in section

The steps of the process according to the embodiments will be explained with reference to FIGS. 1, 2 and 5.

Step 1: Filling of the heater 4; the entire heater including the entire feed and discharge lines, including the start-up facility, is firstly filled and intensively flushed with an inert gas. The breather valves to the equilibration vessel 8 are opened in a regulated manner and the offtake valve 6 remains closed. The chemical substance is then pumped into the heater 4 and also into the cooler 9, with the inert gas being displaced into the equilibration vessel 8. The heater 4 and the cooler 9 are filled until a required degree of fill has been reached in the equilibration vessel 8 and the pump 2 is switched off.

Step 2: Circulation of the chemical substance; to ensure that the inert gas is displaced from all pipes and apparatus components including the heater 4 of the apparatus 0 and the cooler 9 into the equilibration vessel 8, the circulation pump 10 is switched on and the chemical substance is circulated by pumping. The breather valves of the equilibration vessel 8 are then closed and the flushing process is continued with closed valves. When the fill level in the equilibration vessel has dropped significantly during the course of the process, the missing amount has to be fed in by means of the pump 2 until the required fill level has been reached.

Step 3: Introduction of an inert gas cushion into the equilibration vessel; when all of the chemical substance has been introduced into the apparatus 0, the pressure in the apparatus increases automatically. However, the pressure achieved thereby is still far below a critical pressure required in the process. Establishment of a pressure cushion by introduction of pressurized inert gas into the expansion vessel enables the pressure to be brought to the required level above the critical pressure of the chemical substance in the heater plant.

Step 4: Commencement of the introduction of heat; the circulation pump 10 remains in operation during the starting procedure. After flushing of the fire chamber 19 of the heater 4, the burner 5 is started or in the case of the use of waste heat, the waste heat source is switched on. This procedure is commenced with minimum heating power of the heater 4. The substance which has been subjected to little temperature change is continuously and steadily heated in the heater 4, with the material of the entire feed and discharge lines including the valves and cooler 12 also being heated up continuously. The temperature of the chemical substance is not reduced by means of a cooling medium back down to the entry temperature of the chemical substance, and its temperature at the inlet of the heater 4 increases. This procedure is continued at a low heat input until a steady state has been established in the apparatus, with the cooling power of the cooler 9 corresponding to the power set for the heater 4. The required temperature at the exit of the heater 4 can now be set by adjustment of the amount circulated. During the course of the start-up procedure, the chemical substance to be heated expands and the equilibration vessel 8 takes up the increased volume. The pressure in the equilibration vessel 8 increases and its outlet valve 15 is opened to such an extent that the pressure of the inert gas cushion is reduced and at the same time the defined operating pressure is maintained.

Step 5: Introduction of the heated chemical substance into the reactor; when the temperature and the pressure of the chemical substance is constant at minimal heat input, the process has progressed sufficiently far for introduction of the sufficiently heated chemical substance into the subsequent process 14 to be able to be carried out. Since the apparatus is now operating in a steady state, the heated chemical substance can be introduced into the subsequent process 14 at any predetermined time. To limit large temperature changes at the inlet of the heater 4, the pump 2 firstly introduces a further small amount of chemical substance which has been subjected to little temperature change while the circulation pump 10 is still in operation. The pressure in the heater 4 increases as a result of this introduction and the outlet valve 13 opens automatically in order to maintain the operating pressure. To compensate, the circulation pump 10 is slowly throttled back to regulate the exit temperature and the feed pump 2 introduces cold chemical substance which leaves the heater 4 with defined exit temperatures in accordance with requirements. The exit temperature is regulated appropriately in small steps with minimal heat input by means of an injection cooler 12 installed parallel to the heater 4. In the course of the process, a partial amount of the chemical substance to be subjected to controlled heating is branched off at the heater 4 and is reintroduced under pressure at a lower temperature level into the main line 17, 17′. As the amount introduced from the chemicals tank 1 increases, the circulation pump 10 is increasingly throttled back and then switched off. Now, the pump 2 takes over the complete introduction into the heater 4, so that a continuous stream is provided with minimal heat input by the heater 4.

Step 6: Normal operation of the apparatus; on changing over from the minimal power of start-up operation to full load operation, the regulation of the apparatus changes. The required pressure level at the outlet of the heater unit 4 is maintained by opening and closing the outlet valve of the shut-off valve 13 for the main process to the subsequent process 14. After the circulation pump 10 has been switched off, the temperature is maintained at the required temperature by regulation of the heat input in a first stage. With increasing heat input and corresponding output of the pump 2, the heating power increases to full load. In the event of temperature fluctuations exceeding a normal magnitude with the regulation of the heat input, the temperatures are finely adjusted by means of the injection cooler 12, i.e. by injection of chemical substance having a significantly lower temperature than the exit temperature.

Step 7: Running-down of the heater; the thermal input is automatically regulated down by throttling back the pump 2 with the aid of a temperature sensor at the outlet of the heater 4. When minimum load has been reached, the circulation pump 10 is set into operation and the temperature is maintained by regulating the amount circulated. The pump 2 is switched off and the shut-off valve 13 for the main process closes automatically when the defined pressure is exceeded. In the event of a brief interruption, the temperature can be maintained at minimal power by regulation of the amount circulated through the heater 4. When the subsequent process is shut down for a longer period at the transition 14, the heater 4 likewise has to be run down completely. This stops input of heat. Operation of the circulation pump 10 is continued until the cooler 9 has cooled the chemical substance to the temperature for when the plant is not operating.

To carry out the process, the apparatus 0 has the following structure. The apparatus 0 has a chemicals tank 1 in which the chemical substance is present and has sufficiently large dimensions so that reliable supply to the total apparatus can be effected. A pump 2 connected to the chemicals tank 1 serves to increase the pressure to the process pressure and to convey the chemical substance into the heater 4. In this process, the chemical substance has to pass through the shut-off valve 3 for the main process and for the start-up circuit, which valve is also responsible for completely shutting down the apparatus 0 when the facility 18 is used for the start-up process. The construction of the plant is mainly dependent on the plant size, with horizontal and vertical vessels having heating surfaces which are wound and through which transverse or longitudinal flow occurs being able to be employed. The chemical substance can be heated by means of various burner systems in the burner 4, with flame radiation and/or convection of the flue gases being of particular importance. The burner 5 should be given a broad regulation range in the process regime. A person skilled in the art will see that heat from waste heat processes, i.e. including convective heat transfer, can also be provided as an alternative to the burner. As FIG. 3 shows, the flue gases of the burner flow around the heater tubes 20 while the chemical substance flows through them. When the chemical substance leaves the heater 4 at an increased temperature, it is prevented by a shut-off valve 6 from getting into the subsequent process 14. During the start-up process, the preheated substance flows through the shut-off valve 7 to the start-up facility 18. The valve 7 is open only during the start-up process and is closed during normal operation. The expansion vessel 8 is employed only for start-up of the heater unit and at the beginning of the process is completely filled with an inert gas which is compressed on introduction of the chemical substance into the apparatus and its pressure is increased. As explained in detail above, the pressure now present is still far below the critical pressure necessary. The required pressure above a critical pressure is established in the apparatus by additional introduction of gas. During the start-up procedure, the chemical substance expands and the equilibration vessel 8 takes up the increased volume of the chemical substance. The pressure of the inert gas cushion in the expansion vessel 8 increases and the outlet valve 15 is appropriately opened to regulate the pressure. The subsequent cooler 9 for the chemical substance serves to reduce the temperature of the substance which is matched to the function of the subsequent circulation pump 10. The cooling of the chemical substance can be effected by means of various heat transfer media, e.g. air or water. The circulation pump 10 installed in the facility for the start-up process 18 has to operate absolutely drip free and hermetically sealed. To avoid damage, appropriate shut-off valves 11 are provided. When the required temperature has been reached, the shut-off valves 3, 6 in the main circuit are closed or opened in a metered fashion. In this way, the facility for the start-up process is isolated from normal operation. Along the main line 17, 17′ the shut-off valve 6 is followed by an injection cooler 12 which in the event of temperature deviations in the main stream induced by fluctuations in load cools the substance present to the required exit temperature by injection of chemical substances of the same type. The substance to be injected is selected according to the thermal stress which the injection valve will withstand. Downstream of the injection cooler 12, there are safety devices and control valves of designs which can be chosen freely in order to counter a drop in gauge pressure in the apparatus. The shut-off valve 13 in the main line 17, 17′ serves to isolate the heater circuit reliably from the subsequent process at the transition 14. FIG. 3 shows a varied configuration of the start-up facility 18 which can, according to the invention, be employed while retaining the above-described process steps and in which the chemical substance flows via section 16 of the feed line 16; 16′ in the direction of the arrow 28 to the heater 4 in which it is appropriately heated by means of the burner 5. Leaving the heater 4, it flows via section 17 of the main line 17; 17′ with valve 6 closed to a line 22 and then goes into the cooler 9. A person skilled in the art will see that the valve 6 has been installed in the line 17′ in order to counter unexpected backflow of the chemical substance. For the basic function of the varied configuration of the start-up facility, installation of the valve 6 is not necessary and does not impair the operation of the facility 18. The substance flows through a valve 11 located in the line 22′ and via the line section 27 of the line 27; 27′ with the aid of a circulation pump 10 back to the section 16′ of the main line 16; 16′ and goes from there, in the circuit of the start-up process, back into the heater 4 in order to be heated. The ascending part 27′ of the line 27; 27′ is connected to the expansion vessel 8 which can be supplied through a line 15 with nitrogen which can travel via line 25 into the line section 17 for discharge. The introduction of the cooled chemical substance into the expansion vessel 8 firstly moderates the thermal stress on the expansion vessel 8 and secondly improves its functional properties and also effectively improves the introduction and discharge of the inert gas necessary for volume and pressure equilibration. The arrows 28 indicate the respective flow direction of the chemical substance in the circuit of the start-up facility 18.

FIG. 4 shows an embodiment of the facility for the start-up process. In this configuration, the circulation pump 10 is arranged directly downstream of the valve 11 in the line section 22′ and can thus convey the chemical substance at a divided, uniform pressure simultaneously into the line section 27′ and the discharging line section 27 of the start-up circuit from where it can go via the line section 16′ back into the heater 4.

List of the reference numerals used

| | |
|---|---|
| 0 | apparatus |
| 1 | chemicals tank |
| 2 | pump |
| 3; 6; 13 | shut-off valve for main process |
| 4 | heater |
| 5 | burner |
| 7; 11; 11′ | shut-off valve for start-up circuit |
| 8 | expansion vessel |
| 9 | cooler; f. chemicals |
| 10 | circulation pump |
| 12 | injection cooler with regulating valve |
| 14 | transition |
| 15 | valve for expansion vessel |
| 16; 16′ | line |
| 17; 17′ | main line |
| 18 | facility for start-up process |
| 19 | fire chamber |
| 20 | heater tubes |
| 21 | flue gas stream |
| 22; 22′; 27; 27′ | line |
| 23; 26 | valve |
| 24 | cooling medium for the cooler |
| 25 | line |
| 28 | direction arrows for flow direction |

1. A process for the smooth controlled heating of a stream of chemical substances having defined input and output temperatures in a heater, which are passed through the heater while being maintained in a particular defined pressure range, wherein the smooth controlled heating is initiated in a start-up process in a start-up facility inserted between the inlet and outlet of the heater, in which the smooth controlled heating of the chemical substances is carried out with inlet and outlet closed by multiple flow through the heater and the facility until the defined temperature and the predetermined pressure have been reached and, when the defined pressure and temperature conditions have been established, the start-up process is terminated and direct flow through the heater from the inlet to the outlet is established by closing off the start-up facility.

2. The process as claimed in claim 1, wherein the start-up facility is arranged in the apparatus as a bridge between the inlet upstream of the heater and the outlet downstream of the heater and is equipped with functional devices such as an equilibration vessel, an air cooler and a circulation pump.

3. The process as claimed in claim 1, wherein, for the smooth controlled heating of a stream of chemical substances having defined input and output temperatures, an apparatus having a heater is provided and the chemical substance is brought to a supercritical pressure range in the apparatus before exit from the heater within a defined temperature range for the subsequent working steps and the chemical substance is brought by passage through the heater by the start-up facility into a circular start-up process at rising temperature and fill level which is established while maintaining a constant pressure and maintained until leaving the heater.

4. The process as claimed in claim 1, wherein the smooth controlled heating is carried out by:
filling of the heater;
establishment of a gas cushion in an equilibration vessel of the start-up facility so as to achieve the required process pressure;
closing of the valves in the inlet and outlet;
circulation for treatment of the chemical substances with switching on of the start-up facility in a steady-state process and commencement and continuation of the introduction of heat;
introduction of the chemical substance into the downstream processing region with switching off of the start-up process; and
maintenance of continuous operation by conveying the stream from the chemicals tank by the heater into the subsequent working region.

5. The process as claimed in claim 4, wherein both the heater and the start-up facility are filled with gas which passes through the stream of substance present into the expansion vessel and this is placed under pressure until the heater and the apparatus are completely filled.

6. The process as claimed in claim 4, wherein readiness for operation is established by multiple circulation of the chemical substance in the apparatus and by the heater with maintenance of a required fill level for the apparatus and the feed pump located downstream of the chemicals tank is switched off.

7. The process as claimed in claim 4, wherein the pressure of the chemical substance is set and maintained in the region of a critical pressure by production of a pressure cushion by means of an inert gas.

8. The process as claimed in claim 1, wherein the stream to be subjected to controlled heating is formed by chemical substances having vaporizable properties.

9. The process as claimed in claim 1, wherein the stream to be subjected to controlled heating is formed by chemical substances having vaporizable properties and substance mixtures consisting thereof.

10. The process as claimed in claim 4, wherein the burner of the heater is started while maintaining circulation of the medium via the start-up facility assigned to the apparatus, the temperature of the stream of the substance is changed and adjusted by continual heat exchange between a cooler and the chemical substance until a temperature equilibrium of the cooler and the heater power is established and the increased volume is accommodated by means of the equilibration vessel, the pressure to be defined is established by adjustment of the gas cushion and the operating state of the apparatus is set.

11. The process as claimed in claim 4, wherein the heated chemical substance is, when the required temperature and the pressure have been reached in the heater, displaced by targeted introduction of chemical substance which has been subjected to a lesser temperature change and at the transition is discharged from the heater, with its exit temperature being subjected to fine regulation by injection cooling into the stream and its excess temperature being returned to the normal regime and the continuous stream of the substance being adjusted for uniform passage with switching off of the start-up facility.

12. The process as claimed in claim 4, wherein the output quantity of the substance is, in full load operation, offset in a defined ratio from the required operating pressure and the temperature and pressure of the apparatus are kept constant by regulation of the heat input and conducted to full load, with temperature fluctuations being compensated by introduction of chemical substances which have been subjected to a lesser temperature change.

13. The process for the smooth controlled heating of a stream of chemical substances having defined input and output temperatures in a heater, which are conveyed through the heater while being maintained in a particular pressure range, as claimed in claim 1, wherein the smooth controlled heating is initiated in the start-up process in a start-up facility inserted between the inlet and outlet of the heater, in which the smooth controlled heating of the chemical substance is carried out with inlet and outlet closed by multiple flow through the heater and the facility, where the chemical substance coming from the heater in the flow direction of the start-up process is fed to a cooler, cooled therein and thus changed in temperature, is passed through a shut-off valve, flows into an expansion vessel into which the substance is introduced for volume and pressure equilibration of the start-up facility, and the start-up process is continued at equilibrium of the chemical substance in the start-up facility with the aid of a connection to the main line.

14. The process as claimed in claim 11, wherein the chemical substance coming from the heater is fed directly to a cooler and, in a cooled state, is fed to an expansion vessel for volume and pressure equilibration and simultaneously into the circuit of the start-up process.

15. The process as claimed in claim 1, wherein the entry temperature of the chemical substance into the system of the apparatus is 20° C.

16. The process as claimed in claim 1, wherein the exit temperature of the chemical substance from the apparatus is 600° C.

17. The process as claimed in claim 3, wherein the pressure range in the apparatus is set with supercritical parameters.

18. The process as claimed in claim 1, wherein the operating pressure of the apparatus including the heater is set to 40 bar.

19. The process as claimed in claim 1, wherein the setting of the defined pressure in the start-up facility of the apparatus is carried out via a gas cushion in the expansion vessel of the start-up facility by introduction of inert gas.

20. The process as claimed in claim 1, wherein the start-up process is carried out by the start-up facility arranged in the form of a bridging line between the feed and discharge lines by circulation through the heater which is ended when the defined temperature and the required operating pressure of the apparatus have been reached.

21. An apparatus for the smooth controlled heating of chemical substances having defined entry and exit temperatures by heater which is connected to a chemicals tank by a line for introduction and via a main line for discharge of the substance into a subsequent process and between the line and the main line there is a start-up facility for starting up the apparatus, by of which a smooth controlled heating is effected by circulation of the substance stream through the heater with the valve closed and inflow of the chemical substance via an open valve downstream of which there is a cooler which is followed by a shut-off valve which feeds the flowing stream to a pump which conveys the chemical substance to a valve via which, with the valve open, the stream goes into the part of the line, flows back into the heater in which it is subjected to an increasing temperature, repeatedly flows in a circulating fashion into the main line and, when the defined exit temperature has been established and the defined pressure has been established, flows, with valves open and valves closed and with the start-up facility switched off, via the main line to a transition.

22. The apparatus as claimed in claim 21, wherein the start-up facility for smooth controlled heating in the start-up process is switched on and has an inlet valve in the region of the main line which is connected to an expansion vessel which, in active communication with a cooler, conveys the chemical substance to a circulation pump which conveys the stream via a valve into the part of the line connected to the heater and circulation in the facility is continued until the defined operating parameters of the apparatus have been reached.

23. The apparatus as claimed in claim 21, wherein the stream flows into the start-up facility through the open valve into the expansion vessel which is filled with inert gas and in which the defined pressure of the chemical substance is set continuously and incrementally by a gas cushion and then goes to an air cooler which is kept in operation until, at a gradated small heat input into the apparatus, a steady and equilibrium state has been reached, with the circulation pump feeding the chemical substance via the open valve into the line.

24. An apparatus for the smooth controlled heating of chemical substances having defined inflow and outflow temperatures in a heater, which are passed through the heater while being maintained in a particular pressure range, characterized in that a start-up facility which is provided for starting up the apparatus and by which smooth controlled heating is effected by circulation of the stream of substance through the heater with valve open and inflow of the chemical substance via a line in which a cooler is installed and is followed by a shut-off valve which feeds the flowing stream of substance to a pump which is installed in the line section of the line and conveys the stream of substance via the line into part of the line, with an expansion vessel by which volume and pressure equilibration of the start-up facility is established being provided in the line section and a connection which can be shut off by the valve to the main line for the inert gas for volume and pressure equilibration from the expansion vessel being provided via the line, the expansion vessel, by a feed line having a valve, ensuring supply of the gas for pressure regulation in the expansion vessel and the total system of the start-up process, with the chemical substance flowing back at regulated pressure and temperature into the heater in which it is subjected to an increase in temperature, flows repeatedly in a circulating fashion into the main line and, when the defined exit temperature has been established and volume and pressure have been established, flows with valve open to the main line and, with the start-up facility switched off, flows via the main line to a consumer.

25. The apparatus as claimed in claim 22, wherein the chemical substance whose temperature has been changed in the heater flows in the circuit of the start-up facility into the cooler and from there is fed in a cooled state to the expansion vessel which is installed directly downstream of the cooler on the cooled section of the start-up circuit.

26. The apparatus as claimed in claim 22, in that wherein the pump is located in the line section of the line and introduces the chemical substance into the main line.

27. The apparatus as claimed in claim 22, wherein the pump is located in the line downstream of the cooler in the flow direction of the start-up circuit.

28. The apparatus as claimed in claim 21, wherein the heater is formed by a hermetically sealed, pressure-resistant body into whose fire chamber the flame of a burner projects, with the walls of the fire chamber being provided with axially and radially aligned heater tubes which are arranged in a plurality of stages and are connected to one another and through which the chemical substance flows and which are heated by a flue gas stream which changes its direction a plurality of times, with the highest temperature level in each case being reached in the heater tubes located radially outside.

29. The apparatus as claimed in claim 21, wherein a defined temperature is set in the heater by introduction of waste heat from an upstream process.

30. The process as claimed in claim 13, wherein the pressure range in the apparatus is set with supercritical parameters.

31. The process as claimed in claim 14, wherein the pressure range in the apparatus is set with supercritical parameters.

32. The process as claimed in claim 3, wherein the setting of the defined pressure in the start-up facility of the apparatus is carried out via a gas cushion in the expansion vessel of the start-up facility by introduction of inert gas.

33. The process as claimed in claim 7, wherein the setting of the defined pressure in the start-up facility of the apparatus is carried out via a gas cushion in the expansion vessel of the start-up facility by introduction of inert gas.

34. The process as claimed in claim 2, wherein the stream to be subjected to controlled heating is formed by chemical substances having vaporizable properties.

35. The process as claimed in claim 3, wherein the stream to be subjected to controlled heating is formed by chemical substances having vaporizable properties.

36. The process as claimed in claim 3, wherein the stream to be subjected to controlled heating is formed by chemical substances having vaporizable properties and substance mixtures consisting thereof.

37. The process as claimed in claim 3, wherein the entry temperature of the chemical substance into the system of the apparatus is 20° C.

38. The process as claimed in claim 3, wherein the exit temperature of the chemical substance from the apparatus is 600° C.

39. The process as claimed in claim 3, wherein the operating pressure of the apparatus including the heater is set to 40 bar.
